(19) United States
(12) Patent Application Publication
(10) Pub. No.: US 2007/0006119 A1
(43) Pub. Date: Jan. 4, 2007

(54) Method of automatically analysing the structure of a software system

(75) Inventor: Howard Price, Buckinghamshire (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Symbian Software Limited, London (GB)

(21) Appl. No.: 10/560,496

(22) PCT Filed: Jun. 10, 2004
(86) PCT No.: PCT/GB04/02475

§ 371 Date: Jun. 16, 2006

(30) Foreign Application Priority Data
Jun. 12, 2003 (GB) 0313619.9

(51) Int. Cl. G06F 9/44

(52) U.S. Cl. 717/101; 717/131; 717/132

(57) ABSTRACT

The invention automatically produces a structural analysis of a software system's executables, separated into levels based on ‘dependency depth’. Given a simple list of executables' dependencies, the tool automatically produces a dependency table sorted by level, with the least dependent executables listed at the bottom and with the most dependent at the top. This organises the executables in a rational and repeatable manner that clarifies the high-level view of the inter-dependencies between the many executables. It can also be used to decide the order in which executables need to be built where the least dependent executable is built first.

### BACKGROUND OF THE INVENTION

1. Field of the Invention

This invention relates to a method of automatically analysing the structure of a software system, such as an operating system for a computing device.

2. Description of the Prior Art

When trying to gain a high-level view of the inter-dependencies between the many executables (perhaps 500 or more) in an operating system, the view manually arrived at even by a skilled analyst quickly gets obscured by the sheer number of relationships. Hence, it is very difficult to identify inappropriate coupling between components of the OS (e.g. a component where one of its executables depends on a high-level other component for no good reason, indicating perhaps bad layering or inappropriate inclusion of an executable in the component).

Further, it is very helpful to be able to calculate the order in which executables and groups of strongly inter-dependent executables (e.g. components) should be built to ensure that executables with the least number of dependenceis are built first. But this is again difficult, even for the skilled analyst, and can take several days. Performing regular (e.g. daily or weekly) re-calculations as an OS build progresses is therefore impractical when relying on a highly skilled, but essentially manual process.

Glossary

| Term | Description |
|---|---|
| Dependency | An executable is said to depend on another |
| | executable if it calls one or more of the exported |
| | functions in the other executable. |
| Executable or | Generic term used to specify either a DLL or EXE, |
| executable file | containing binary code directly runnable by the |
| | computer. A DLL provides exported functions for use |
| | by other executables. An EXE is a self-contained |
| | program and generally provides a single entry point. |
| Exported | The set of functions provided by a DLL that may be |
| functions | called by other executables. |

### SUMMARY OF THE INVENTION

The invention automatically produces a structural analysis of a software system's executables, separated into levels based on the concept of ‘dependency depth’.

Given a simple list of executables' dependencies, a tool that implements the invention automatically produces a dependency table sorted by ‘dependency depth’ level, with the least dependent executables listed at the bottom and with the most dependent at the top. Executables with circular dependencies are not problematic, with the executables involved automatically being treated as being at the same level as each other.

The tool achieves this by assigning a unique and well-defined ‘dependency depth’ number to each executable. This number defines how many levels exist in the executable's dependency tree. This number may be calculated by expanding that executable's dependency tree recursively so that each executable is listed in expanded form exactly once in the tree for the right-most occurrence only, and is listed in collapsed form for all other occurrences. This guarantees that the tree is as deep as possible and is therefore also unique, making it usable for sorting a set of executables according to their dependency depth numbers.

Using the table that is produced in this way simplifies the production of a block diagram based on dependency, with executables at the same dependency level grouped together horizontally in the block diagram. Hence, the present invention provides a mechanism that organises the executables in a rational and repeatable manner that clarifies the high-level view of the inter-dependencies between the many executables. It can also be used to decide the order in which executables need to be built where the least dependent executable is built first.

With further information giving the grouping of executables into components, the same technique may be used to find the dependency depth number of a component, where a component is a group of related executables which have strong inter-dependencies, usually built and deployed as a unit. Component M depends on component N if any executable in M calls a function of any executable in N.

Summary of the Benefits of the Present Invention
Better understanding of OS interdependencies through a systematic, reliable and comprehensive analysis of the system architecture. A system architect can find inappropriate coupling between components of the OS—e.g. a component where one of its executables depends on a high-level other component for no good reason, indicating perhaps bad layering or inappropriate inclusion of an executable in the component;
Enables automatic, rapid and reliable calculation of the order in which components should be built. Items at low levels are guaranteed to be buildable without previously building items at higher levels. Circular dependencies need to be built together;
Results of the analysis can be used by other tools;
Leads to improved modularity, aiding rollout of independent features;
Helps produce a block diagram of the OS.

### DETAILED DESCRIPTION

To simplify this description, we will use specific examples of very simple hypothetical Operating Systems that have only a small number of executables.

If executable A calls a function in executable B and another function in executable C, A is said to depend directly on both B and C. This can be represented by the following line:
A: BC

where the executable on the left of the colon depends directly on the executables on the right

### EXAMPLE 1

No Circular Dependencies

The following table specifies the complete direct dependency structure of a hypothetical OS with six executables, A, B, C, D, E and F:

A: B C
B: C
C:
D: A C E
E: A
F: E

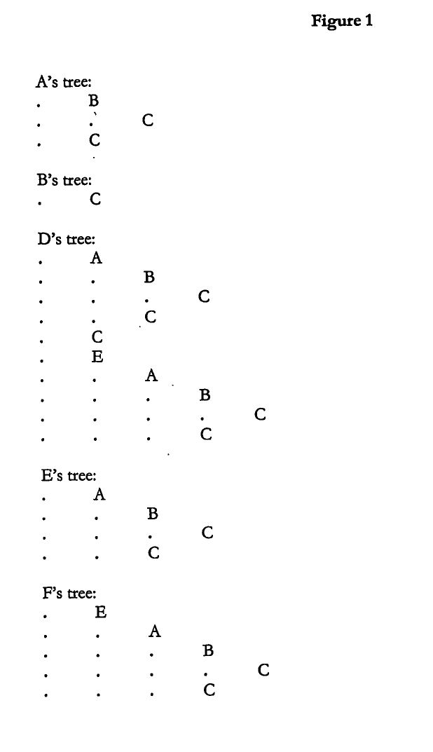

Using this direct dependency structure, a dependency tree can be generated for each executable which includes direct dependencies as well as their dependencies and so on recursively, as shown in FIG. 1:

In these representations of the dependency trees, a direct dependency is indented by one tab to the right of the executable that depends on it, so as before:
1. E depends directly on A only
2. D depends directly on A, C and E
3. A depends directly on B and C
4. B depends directly on C only
5. C depends on nothing.

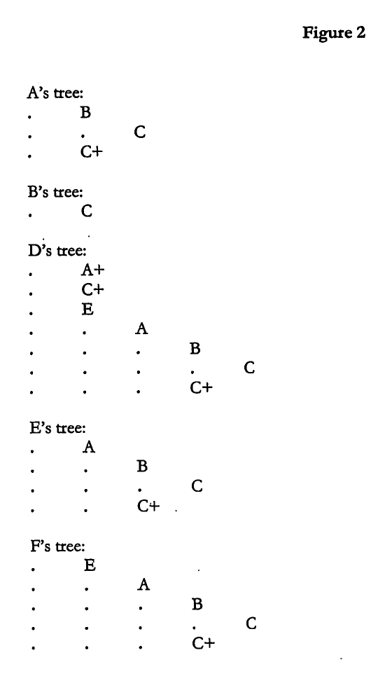

This can be simplified by collapsing sub-trees that are repeated in the tree, giving the following trees, where a ‘+’ indicates a collapsed executable sub-tree, expanded further to the right somewhere else in the tree, as shown in FIG. 2:

Collapsing repeats is important for the tool's memory and speed efficiency when analysing a real OS, with potentially thousands of executables and millions of repeated sub-trees within each tree. See an algorithm for achieving this efficiently below.

Each executable can then be assigned a unique dependency depth number by counting the levels of indentation, given by the maximum number of dots in any row for the specified executable's tree above.

| Executable | Dependency Depth Number |
|---|---|
| A | 2 |
| B | 1 |
| C | 0 |
| D | 4 |
| E | 3 |
| F | 4 |

The dependency depth number can now be used to partition the OS into levels with executables having the lowest dependency depth number at the bottom as follows

| | |
|---|---|
| Level 4: | D, F |
| Level 3: | E |
| Level 2: | A |
| Level 1: | B |
| Level 0: | C |

### EXAMPLE 2

Includes Circular Dependencies

The following table specifies the complete direct dependency structure of a second hypothetical OS:

A: B C
B: C
C: A

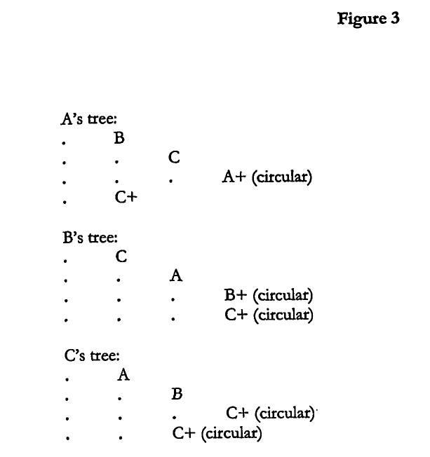

Using this direct dependency structure, the dependency trees are represented as follows—where recursion stops on reaching a circular dependency to avoid infinite regress, as shown in FIG. 3:

Again the unique dependency depth number is found by counting the levels of indentation, given by the maximum number of dots in any row above.

| | Dependency Depth |
|---|---|
| Executable | Number |
| A | 3 |
| B | 3 |
| C | 3 |

Partitioning the OS into levels again using these dependency depths produces the following:

Level 3:
A, B,C

Note that the circular dependencies cause empty levels 0, 1 and 2.

Efficient Algorithm for Collapsing Repeated Sub-Trees

A real OS has potentially thousands of executables and millions of repeated sub-trees within each tree, so an algorithm for collapsing repeats efficiently and in an easily searchable and parseable way, is very important for a workable tool.

As described below, the finally generated tree for D from example 1 above can be stored efficiently as a single easily computer-searchable and parseable string as follows:
D's tree=‘A+C+E:1{A:2{B:3{C:4{}C}BC+}A}E’

The format of a collapsed executable Y is simply ‘Y+’

The format of an executable Z that has a circular dependency on it is ‘Z+(circular)’

The start tag for executable X's expansion at indentation level L is

‘X:L {‘

and its end tag is

’}X’

and between the braces are the details for the executables X depends on which is empty for an executable with no dependencies.

To build e.g. D's tree from example 1, named D-tree here for convenience, follow these steps, noting that substrings enclosed by angle brackets represent variable quantities:
1. Initialise D-tree to empty string “‘”
2. For each executable used by D (i.e. for X=A, X=C and X=E) do the expansion in step 3 at level L=1
3. Add used executable X at level L:
a) If X equals D, add ‘X+(circular)’ and finished step 3 for X
b) Search for previously added partial expansion ‘X:M {‘in D-tree with no terminating’}X’ and if found, signifies a partially built expansion and therefore a circular dependency, so add ‘X+(circular)’
c) Search for previous expansion ‘X:M {<anyText>}X’ in D-tree where M is a previously added level number
d) If found and L is less than or equal to M, add ‘X:L+’ and finished step 3 for X
e) If found and L is greater than M, replace previously added ‘X:M {<anyText>}X’ by ‘X:M+’
f) Now add the expansion
   i. Add ‘X:L {’ marking expansion start for X
   ii. Add expansion for each executable used by X at level L+1 (i.e. repeat step 3 for all executables used by X recursively)
   iii. Add ‘}X’ marking expansion end for X

Note that at step 3f) above the previously found expansion from step 3a) above can't be used for further efficiency, because that expansion will include executables that themselves are expanded to a different level than required in step 3f) above.

Here is the full tree expansion for the OS described in example 1:
A=>‘B:1{C:2{}C}BC+’
B=>‘C:1{}C’
C=>‘ ’
D=>‘A+C+E:1{A:2{B:3{C:4{}C}BC+}A}E’
E=>‘A:1{B:2{C:3{}C}BC+}A’
F=>‘E:1{A:2{B:3{C:4{}C}BC+}A}E’

And here is the expansion for the OS described in example 2:
A=>‘B:1{C:2{A+(circular)}C}BC+’
B=>{C:1{A:2{B+(circular)C+(circular)}A}C’
C=>‘A:1{B:2{C+(circular)}BC+(circular)}A’

The maximum number in this string gives the dependency depth for the executable when it is followed by an empty expansion ‘{}’. When not followed by an empty expansion, adding 1 to the maximum number in the string gives the dependency depth, handling the case of a circular dependency at the deepest level in the tree.

Symbian OS v7.0s with more than 550 executables produces a full definition of this kind that has size 810K.

1. A method of automatically analysing the structure of a software system, comprising the step of using an automated software tool to determine the dependency depth level of each of several executables and to then partition the system by organising the executables into their respective dependency depth levels.

2. The method of claim 1 in which the tool outputs a dependency table in which each of the executables is sorted according to dependency depth.

3. The method of claim 2 in which executables with circular dependencies are placed at the same level.

4. The method of claim 3 in which the tool assigns a dependency depth number to each executable, calculated by expanding each executable's dependency tree recursively so that each executable is listed in expanded form exactly once in the tree for the right-most occurrence only, and is listed in collapsed form for all other occurrences.

5. The method of claim 4 in which the tool is further able to determine the dependency depth level of each of several components, each comprising a group of related executables with strong inter-dependencies.

6. The method of claim 1 in which the software system is an operating system.

7. A software based tool that automatically analyses the structure of a software system, the tool programmed to determine the dependency depth level of each of several executables and to then partition the system by organising the executables into their respective dependency depth levels.

8. An operating system which is automatically analysed during its design, implementation or maintenance phases by an automated software tool that determines the dependency depth level of each of several executables and then partitions the system by organising the executables into their respective dependency depth levels.
